(19) United States
(12) Patent Application Publication
(10) Pub. No.: US 2026/0339822 A1
(43) Pub. Date: Oct. 29, 2026

(54) MULTI-TIER APPLICATION ARCHITECTURE FAILURE MANAGEMENT

(71) Applicant: International Business Machines Corporation, Armonk, NY (US)

(72) Inventors: Sunil KUMAR RAMAKRISHNA RAO, Bengaluru (IN); Balram BALAKRISHNAN, BANGALORE (IN); Madhusmita P. PATIL, Hyderabad (IN); Dinesh Kumar BHUDAVARAM, Bangalore (IN)

(21) Appl. No.: 19/190,155

(22) Filed: Apr. 25, 2025

(51) Int. Cl. G06F 11/362

(52) U.S. Cl. CPC G06F 11/366

(57) ABSTRACT

Baseline data indicative of one or more sets of baseline metrics corresponding to a multi-tier application architecture is determined based on workload data associated with the multi-tier application architecture. Impact data associated with at least one dependency metric corresponding to the multi-tier application architecture is determined based on runtime data associated with the multi-tier application architecture. Output data indicative of a mitigation inference associated with the multi-tier application architecture is output based on a machine learning component configured to process the baseline data and the impact data.

### BACKGROUND

The present invention relates to multi-tier application deployments, and for example, relates to multi-tier application architecture failure management.

### SUMMARY

In one embodiment, a computer-implemented method is provided. In this embodiment, the method includes determining, based on workload data associated with a multi-tier application architecture, baseline data indicative of one or more sets of baseline metrics corresponding to the multi-tier application architecture. The method further includes determining, based on runtime data associated with the multi-tier application architecture, impact data associated with at least one dependency metric corresponding to the multi-tier application architecture. Additionally, the method includes outputting, based on a machine learning component configured to process the baseline data and the impact data, output data indicative of a mitigation inference associated with the multi-tier application architecture.

In another embodiment, a computer program product is provided. In this embodiment, the computer program product includes one or more computer-readable storage media and program instructions stored on the one or more computer-readable storage media to perform operations. The operations include determining, based on workload data associated with a multi-tier application architecture, baseline data indicative of one or more sets of baseline metrics corresponding to the multi-tier application architecture. The operations further include determining, based on runtime data associated with the multi-tier application architecture, impact data associated with at least one dependency metric corresponding to the multi-tier application architecture. Additionally, the operations include outputting, based on a machine learning component configured to process the baseline data and the impact data, output data indicative of a mitigation inference associated with the multi-tier application architecture.

In yet another embodiment, a computer system is provided. In this embodiment, the computer system includes a processor set, one or more computer-readable storage media, and program instructions stored on the one or more computer-readable storage media to cause the processor set to perform operations. The operations include determining, based on workload data associated with a multi-tier application architecture, baseline data indicative of one or more sets of baseline metrics corresponding to the multi-tier application architecture. The operations further include determining, based on runtime data associated with the multi-tier application architecture, impact data associated with at least one dependency metric corresponding to the multi-tier application architecture. Additionally, the operations include outputting, based on a machine learning component configured to process the baseline data and the impact data, output data indicative of a mitigation inference associated with the multi-tier application architecture.

### BRIEF DESCRIPTION OF THE DRAWINGS

FIG. 1A is a block diagram of an example computing environment described herein.

FIG. 1B is a data flow diagram associated with the example computing environment of FIG. 1A.

FIGS. 2A-2C are schematic diagrams showing examples of multi-tier application architecture failure management described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with multi-tier application architecture failure management described herein.

### DETAILED DESCRIPTION

The following detailed description of example implementations refers to the accompanying drawings. The same reference numbers in different drawings may identify the same or similar elements.

N-tier application architectures, also referred to as multi-tier architectures, represent a common structural model for enterprise software systems wherein the application functionality is logically and physically separated across two or more distinct layers or “tiers.” Typical tiers in such an architecture include, but are not limited to, a presentation tier (e.g., user interface or web front-end), an application or business logic tier (e.g., application servers processing domain logic), and a data tier (e.g., database management systems storing structured or unstructured data). Additional intermediate tiers, such as integration or configuration services, caching layers, and messaging systems, may also be present depending on deployment complexity. These tiers communicate over defined interfaces or network protocols, and the separation enables modularity, scalability, and maintainability of enterprise software deployments.

Multi-tier application architectures have become increasingly prevalent in modern enterprise software systems, offering enhanced modularity, scalability, and maintainability. However, these complex deployments introduce challenges in managing system failures and performance degradation across interconnected tiers. When issues arise, IT administrators often struggle to quickly identify the root cause and determine the appropriate corrective action, leading to extended downtime and resource-intensive troubleshooting efforts.

A technical challenge lies in efficiently analyzing the vast amount of operational data generated across tiers to pinpoint the source and scope of failures. Current approaches frequently rely on manual investigation of logs and metrics from multiple system components, which is time-consuming and error-prone. Additionally, the interdependencies between tiers make it difficult to isolate problems and assess their impact, often resulting in overly broad restoration efforts that unnecessarily disrupt unaffected parts of the system.

The lack of automated, intelligent analysis capabilities forces many organizations to default to full system rollbacks or restorations as a precautionary measure, even when more targeted interventions would suffice. This conservative approach leads to excessive downtime, potential data loss, and inefficient use of computing resources. Furthermore, the absence of machine learning-driven insights means that patterns in historical failure data are not effectively leveraged to predict and prevent future issues, leaving systems vulnerable to recurring problems.

Existing tools for multi-tier application management typically focus on monitoring individual tiers rather than holistically analyzing cross-tier dependencies and failure propagation. This siloed approach hampers the ability to quickly determine optimal mitigation strategies, particularly in cases where issues originate in one tier but manifest symptoms in others. As a result, IT teams often struggle to make data-driven decisions about whether partial or full system restoration is necessary, leading to suboptimal recovery processes and extended service disruptions.

Implementations of this disclosure address problems such as these by providing a system and method for intelligent failure management in multi-tier application architectures. The disclosed approach utilizes workload characterization, dependency modeling, and machine learning techniques to analyze system behavior across tiers, identify root causes of issues, and recommend targeted mitigation strategies.

In some implementations, the system may determine baseline data indicative of one or more sets of baseline metrics corresponding to the multi-tier application architecture. This baseline data may be derived from workload data associated with the architecture. As used herein, the term “baseline data” refers to a set of reference metrics that represent normal or expected system behavior. For example, baseline data may include average response times, error rates, or resource utilization levels for different components or tiers of the application. The baseline data may be organized into multiple time slices, with each time slice containing sets of metrics for different tiers of the architecture.

The system may also determine impact data associated with at least one dependency metric corresponding to the multi-tier application architecture. This impact data may be based on runtime data associated with the architecture. As used herein, the term “impact data” refers to information about how changes or issues in one part of the system affect other components or tiers. For example, impact data may include a mapping of system changes to affected tiers, or a model of component interactions and dependencies. In some implementations, the impact data may be represented as an impact matrix indicating which tiers are impacted by specific activities or changes.

A machine learning component may be configured to process the baseline data and the impact data to generate output data indicative of a mitigation inference associated with the multi-tier application architecture. As used herein, the term “mitigation inference” refers to a recommendation or decision about how to address a detected issue or anomaly in the system. For example, a mitigation inference may suggest a partial restoration of a specific tier, a rollback of recent changes, or a full system restore. The machine learning component may be trained on historical data from the current architecture or similar deployments to improve its decision-making capabilities over time.

In some implementations, the system may include a workload characterization component that analyzes various aspects of system behavior to generate the baseline data. This may involve obtaining and processing failure codes from hypertext transfer protocol (HTTP) request/response interactions, identifying patterns of repeated requests, collecting system performance metrics, and analyzing trends in support tickets or user-reported issues. Each of these data sources may contribute to a comprehensive view of normal system operation across different tiers and time periods.

The system may include a dependency modeling component that dynamically monitors the multi-tier application architecture during runtime to create a component interaction model. This model may be used to perform dependency analysis and detect relationships between different parts of the system. In some implementations, the dependency modeling may involve creating an impact matrix that maps specific activities or changes to the tiers they affect, enabling more precise targeting of mitigation efforts.

The output data generated by the machine learning component may include specific instructions for a mitigation engine to execute, allowing for automated or semi-automated resolution of detected issues. In some implementations, the system may provide recommendations to human operators, who can then decide whether to approve and implement the suggested actions. This approach combines the speed and analytical power of machine learning with human expertise and oversight.

By providing a holistic, data-driven approach to failure management in multi-tier architectures, this disclosure enables more efficient and targeted mitigation strategies. The system's ability to analyze cross-tier dependencies and historical patterns allows for faster root cause identification and more precise interventions, reducing downtime and resource waste compared to traditional full-system rollback approaches. This technical solution represents an advancement over existing monitoring and management tools by integrating real-time analysis, machine learning, and automated mitigation capabilities.

In some implementations, the system determines baseline data indicative of one or more sets of baseline metrics corresponding to the multi-tier application architecture. Accordingly, an advantage of the baseline data determination is the ability to establish a comprehensive reference point for normal system behavior across multiple tiers. Additionally, an advantage of the baseline data determination is the capture of time-trended performance metrics, enabling the detection of gradual degradation or anomalies. Furthermore, an advantage of the baseline data determination is the incorporation of diverse data sources, including HTTP request/response failures, repeated requests, system performance metrics, and support ticket trends, providing a holistic view of system health.

In some implementations, the system determines impact data associated with at least one dependency metric corresponding to the multi-tier application architecture. Accordingly, an advantage of the impact data determination is the ability to dynamically model component interactions and dependencies during runtime. Additionally, an advantage of the impact data determination is the creation of an impact matrix that maps specific activities to affected tiers, enabling precise targeting of mitigation efforts. Moreover, an advantage of the impact data determination is the enhanced understanding of cross-tier dependencies, allowing for more accurate root cause analysis and reducing the risk of unintended consequences during restoration or rollback actions.

In some implementations, the system utilizes a machine learning component configured to process the baseline data and the impact data to generate output data indicative of a mitigation inference. Accordingly, an advantage of the machine learning-based mitigation inference is the ability to leverage historical data and patterns to improve decision-making over time. Additionally, an advantage of the machine learning-based mitigation inference is the potential for automated or semi-automated resolution of detected issues, reducing response times and human error. Furthermore, an advantage of the machine learning-based mitigation inference is the capability to recommend targeted actions, such as partial restorations or rollbacks, minimizing unnecessary disruptions to unaffected parts of the system and optimizing resource utilization during recovery processes.

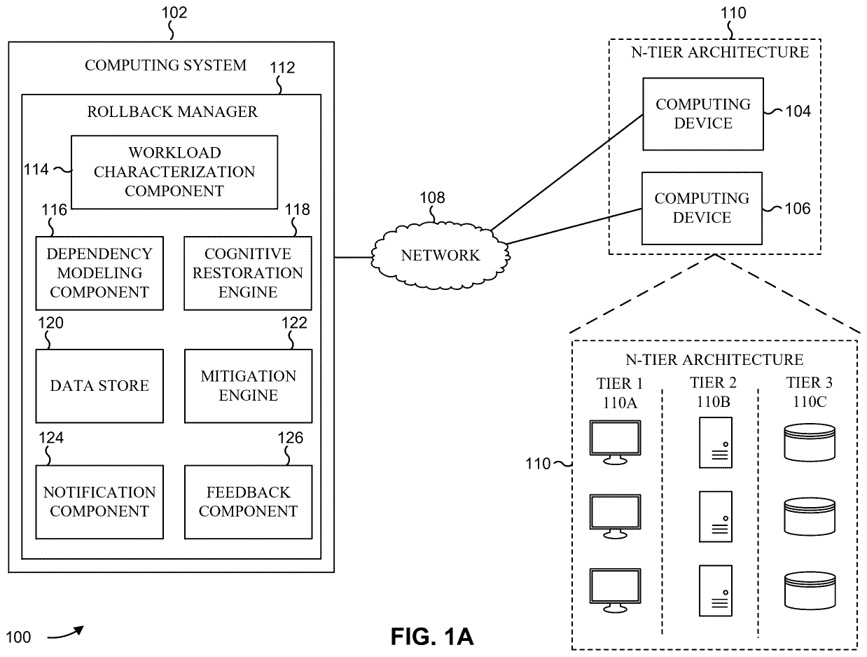

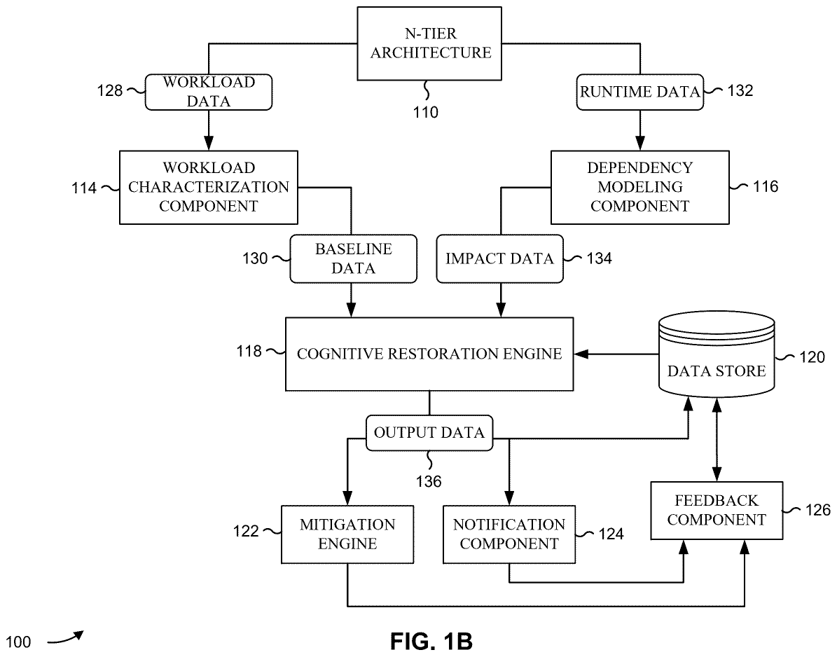

FIG. 1A illustrates a block diagram of an example computing environment 100 for managing failures in a multi-tier application architecture. As shown, the computing environment 100 includes a computing system 102, computing devices 104 and 106, and a network 108. As shown, the computing devices 104 and 106 may implement an n-tier architecture 110.

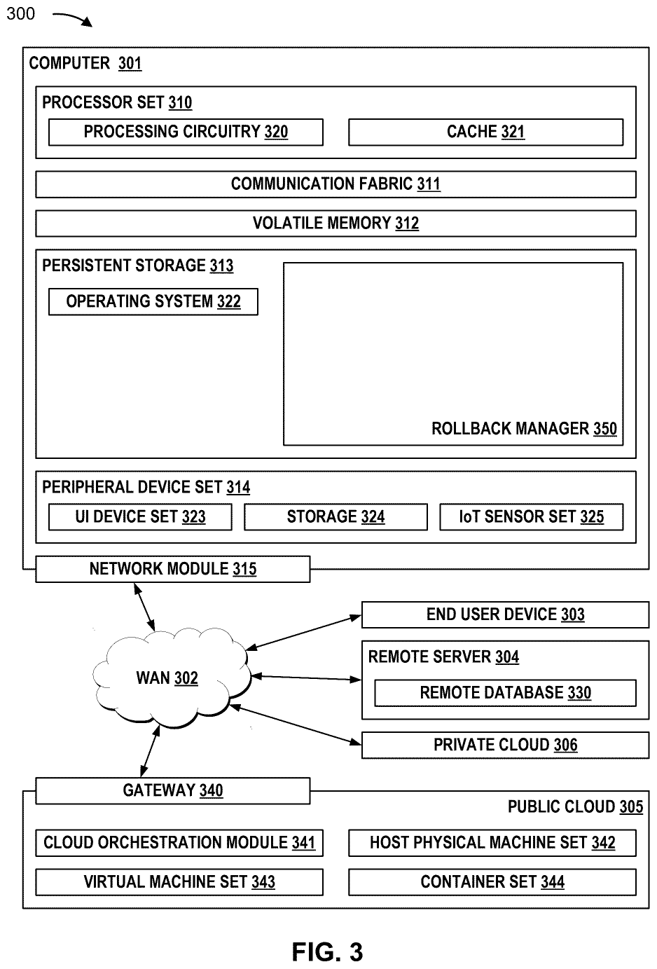

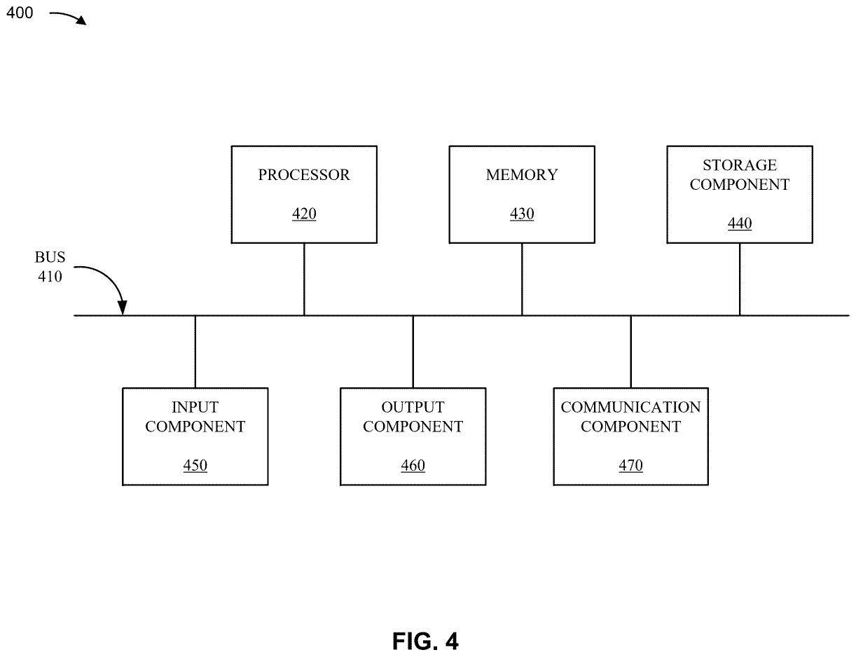

The computing system 102 may be a server system, a cloud computing platform, or a mainframe computer. In some implementations, the computing system 102 may be implemented using any number of servers, workstations, desktops, laptops, and the like. In some implementations, the computing system 102 may be implemented using one or more components of the computing environment 300 described in connection with FIG. 3 and/or the device 400 described in connection with FIG. 4. In some implementations, the computing system 102 may be integrated with the n-tier architecture 110, while in other implementations, the computing system 102 may be separate from but communicatively coupled to the n-tier architecture 110.

The computing devices 104 and 106 may be any type of computing device, such as a desktop computer, a laptop computer, a tablet computer, a smartphone, or a virtual machine. In some implementations, the computing devices 104 and 106 may be implemented using one or more components of the computing environment 300 described in connection with FIG. 3 and/or the device 400 described in connection with FIG. 4. As indicated above, the computing device 104 and/or 106 may implement the n-tier architecture 110. The n-tier architecture 110 may be, for example, a three-tier architecture or an n-tier architecture with any number of tiers. The n-tier architecture 110 may include any number of computing devices 104, 106. The n-tier architecture 110 may be managed, alone or in combination, by a cloud or on-premises service provider. Each tier of the n-tier architecture 110 may include any number of components implemented, for example, using the computing device 104 and/or 106. For example, as shown in FIG. 1A, the n-tier architecture may include a tier 1 110A (e.g., a presentation tier), a tier 2 110B (e.g., an application tier), and a tier 3 110C (e.g., a database tier). The n-tier architecture 110 may be implemented using various hardware and software combinations. For example, a presentation tier may be implemented using web servers running on computing device 104, an application tier may be implemented using application servers running on computing device 106, and a data tier may be implemented using a database server running on the computing system 102. In another example, all three tiers may be implemented on a single computing device, such as the computing system 102, or distributed across multiple computing devices and cloud-based services.

As shown, the computing system 102 includes a rollback manager 112. In some implementations, the rollback manager 112 may be implemented using the computing device 104, the computing device 106, and/or a combination of the computing system 102, the computing device 104, and/or the computing device 106. The rollback manager 112 may be configured to perform failure management associated with the n-tier architecture 110, as described herein. For example, the rollback manager 112 may be configured to determine baseline data indicative of one or more sets of baseline metrics corresponding to the multi-tier architecture, and determine impact data associated with at least one dependency metric corresponding to the multi-tier architecture. The rollback manager 112 may be further configured to generate and provide output data indicative of a mitigation inference associated with the multi-tier architecture based on a machine learning component configured to process the baseline data and the impact data. The mitigation inference may include, for example, recommendations or suggestions for mitigating detected failures or issues associated with the n-tier architecture 110. The rollback manager 112 may further be configured to train the machine learning component based on historical data associated with at least one of the multi-tier architecture or another multi-tier architecture having a configuration similarity with a configuration of the multi-tier architecture. The rollback manager 112 may be further configured to train the machine learning component based on the baseline data, the impact data, and the output data.

Mitigations may include, for example, a partial rollback, a partial restoration, a full restoration, a full rollback, or even a full system shutdown. As used herein, a rollback refers to the reversal of one or more changes made to a software system, such as application code updates, configuration modifications, or deployment operations. A full rollback denotes the reversal of all recent changes across multiple tiers of a system, typically restoring the entire deployment to a pre-change baseline. In contrast, a partial rollback involves reverting only a subset of the changes, such as those applied to a single tier or component (e.g., reverting only the application tier while leaving the database tier intact). A restore, by comparison, involves reinstating a component or system to a previously captured operational state using backup or snapshot data. A full restore refers to restoring the complete system or all tiers to a prior known-good state, whereas a partial restore reinstates only specific components or tiers. While rollback is typically change-driven, seeking to undo specific modifications, restore is state-driven, aiming to recover a predefined system state without necessarily identifying or reversing individual changes.

The rollback manager 112 further includes a workload characterization component 114, a dependency modeling component 116, a cognitive restoration engine 118, a data store 120, a mitigation engine 122, a notification component 124, and a feedback component 126. Any one or more of the rollback manager 112, the workload characterization component 114, the dependency modeling component 116, the cognitive restoration engine 118, the mitigation engine 122, the notification component 124, and the feedback component 126 may be implemented as hardware and/or software components running on one or more of the computing system 102, or the computing devices 104 and 106. These components may be written in any suitable programming language and may be deployed as standalone applications, web services, or microservices. In some implementations, any two or more of the rollback manager 112, the workload characterization component 114, the dependency modeling component 116, the cognitive restoration engine 118, the mitigation engine 122, the notification component 124, and the feedback component 126 may be combined into a single component.

The workload characterization component 114 may be configured to determine, based on workload data associated with the n-tier architecture 110, baseline data indicative of one or more sets of baseline metrics corresponding to the n-tier architecture 110. In some implementations, the workload characterization component 114 may obtain failure codes associated with HTTP request response failures corresponding to at least one tier of the n-tier architecture 110. The workload characterization component 114 may then determine a set of baseline metrics based on these failure codes, where the set of baseline metrics may include at least one time-series HTTP request response metric.

The workload characterization component 114 may be configured to analyze various aspects of system behavior to generate comprehensive baseline data. In some implementations, the workload characterization component 114 may obtain and process data related to repeated HTTP requests, which can provide insights into potential system issues or user behavior patterns. For example, the workload characterization component 114 may examine the frequency and timing of repeated requests to determine if they are intentional (such as a user refreshing a query result) or indicative of an anomaly within the system. This analysis may contribute to a more nuanced understanding of normal system operations across different tiers and time periods.

In some cases, the workload characterization component 114 may incorporate system performance metrics into its baseline data generation process. These metrics may include, but are not limited to, CPU utilization, memory usage, disk I/O, network traffic, and application-specific performance indicators. By tracking these metrics over time, the workload characterization component 114 may establish baseline performance levels for different parts of the n-tier architecture 110, enabling the detection of gradual performance degradation or sudden anomalies. In some implementations, the workload characterization component 114 may analyze trends in support tickets or user-reported issues, which can provide valuable context for understanding system health and user experience.

The workload characterization component 114 may utilize various data sources and collection methods to gather the information needed for baseline characterization. In some implementations, it may leverage HTTP archive (HAR) files, application log files, or network traffic data captured through tools like Wireshark. The workload characterization component 114 may also be capable of initiating targeted data collection sessions, such as enabling HTTP logging or network packet capture during specific activities, to gather more detailed information about system behavior under different conditions. This flexible approach to data collection may allow the workload characterization component 114 to adapt to different deployment scenarios and provide a comprehensive view of system performance across all tiers of the n-tier architecture 110.

The dependency modeling component 116 may be configured to determine, based on runtime data associated with the n-tier architecture 110, impact data associated with at least one dependency metric corresponding to the n-tier architecture 110. In some implementations, the dependency modeling component 116 may obtain the runtime data by dynamically monitoring the n-tier architecture 110 during runtime. The dependency modeling component 116 may create a component interaction model associated with the n-tier architecture 110 based on the runtime data and perform dependency modeling on the component interaction model to detect at least one set of dependency metrics associated with the n-tier architecture 110.

The dependency modeling component 116 may employ various techniques to analyze and model the complex interactions within the n-tier architecture 110. In some implementations, the dependency modeling component 116 may utilize graph-based representations to capture the relationships between different components, services, and tiers. This graph-based approach may allow for efficient traversal and analysis of dependencies, enabling the system to quickly identify potential impact paths when changes or failures occur in specific parts of the architecture. The dependency modeling component 116 may also incorporate temporal aspects into its models, tracking how dependencies evolve over time and under different load conditions.

In some cases, the dependency modeling component 116 may leverage machine learning algorithms to improve its dependency detection and impact prediction capabilities. For example, the component may use supervised learning techniques to train models on historical data, correlating observed system behaviors with known dependencies and impacts. Alternatively, unsupervised learning approaches may be employed to discover hidden patterns or clusters in the runtime data that may indicate previously unknown dependencies. The dependency modeling component 116 may also utilize reinforcement learning techniques to continuously refine its models based on feedback from actual system events and the outcomes of mitigation actions.

The dependency modeling component 116 may be designed to handle dynamic and evolving architectures, adapting its models in real-time as new components are added, removed, or modified within the n-tier architecture 110. This adaptability may be particularly valuable in cloud-native environments where microservices and containerized applications frequently scale up or down. The dependency modeling component 116 may consider both direct and indirect dependencies, accounting for complex chains of interactions that may not be immediately apparent from surface-level analysis. By providing a comprehensive and up-to-date view of system dependencies, the dependency modeling component 116 may facilitate generation of impact assessments and targeted mitigation strategies when issues arise in the n-tier architecture 110.

The cognitive restoration engine 118 may be configured to output, based on a machine learning component configured to process the baseline data and the impact data, output data indicative of a mitigation inference associated with the n-tier architecture 110. In some implementations, the cognitive restoration engine 118 may recommend a restoration action, a partial restoration action, a rollback action, or a partial rollback action based on the processed baseline data and impact data.

The cognitive restoration engine 118 may utilize advanced machine learning techniques to analyze the interplay between baseline data and impact data in the n-tier architecture 110. In some implementations, the cognitive restoration engine 118 may employ ensemble learning methods, combining multiple machine learning models such as decision trees, neural networks, and support vector machines to improve the accuracy and robustness of its mitigation inferences. This approach may allow the cognitive restoration engine 118 to capture diverse patterns and relationships within the data, thereby facilitating more nuanced and effective restoration strategies.

The cognitive restoration engine 118 may incorporate a temporal dimension into its analysis, considering not only the current state of the n-tier architecture 110 but also historical trends and patterns. In some cases, the cognitive restoration engine 118 may use time series analysis techniques to identify cyclical patterns, seasonal variations, or long-term trends in system behavior that could influence the choice of mitigation strategy. This temporal awareness may enable the cognitive restoration engine 118 to distinguish between transient anomalies and more persistent issues, facilitating reduction of false positives and improving the overall efficiency of the restoration process.

In some implementations, the cognitive restoration engine 118 may be designed with explainable AI principles in mind, providing transparency into its decision-making process. In some implementations, the cognitive restoration engine 118 may generate detailed explanations for its mitigation inferences, including the factors that influenced the decision, the confidence level of the recommendation, and potential alternative strategies. This explainability feature may enhance trust in the system's recommendations and facilitate collaboration between the automated restoration process and human operators, who can review and validate the proposed actions before implementation.

The data store 120 may be configured to store various types of data used by the rollback manager 112, including historical data, configuration data, and machine learning models. In some implementations, the cognitive restoration engine 118 may be trained based on historical data associated with at least one of the n-tier architecture 110 or another multi-tier application architecture having a configuration similarity with a configuration of the n-tier architecture 110.

The data store 120 may be implemented using various storage technologies, including relational databases, NoSQL databases, or distributed file systems, depending on the specific requirements of the rollback manager 112. In some implementations, the data store 120 may utilize a combination of storage technologies to optimize performance and scalability. For example, frequently accessed data may be stored in a high-speed in-memory database, while historical data may be archived in a more cost-effective object storage system.

The data store 120 may implement data partitioning and replication strategies to ensure high availability and fault tolerance. In some cases, the data store 120 may employ sharding techniques to distribute data across multiple nodes, allowing for horizontal scalability as the volume of stored data grows. The data store 120 may also incorporate backup and recovery mechanisms, such as point-in-time recovery and incremental backups, to protect against data loss and facilitate rapid restoration in case of system failures.

In some implementations, the data store 120 may include a data versioning system that tracks changes to stored data over time. This versioning capability may allow the rollback manager 112 to analyze historical trends, compare system states across different time periods, and potentially roll back to previous configurations if needed. The data store 120 may implement access control and encryption mechanisms to ensure the security and privacy of sensitive data, such as system configuration details or machine learning model parameters.

The network 108 may facilitate communication between the computing system 102 and the computing devices 104 and 106 within the n-tier architecture 110. In some implementations, the network 108 may include a wide area network (WAN), a local area network (LAN), or a combination thereof. The network 108 may use various communication protocols to enable data exchange between the components of the computing environment 100. The network 108 may include any number of wireless networks, wired networks, or a combination thereof.

In operation, the computing system 102 may continually, periodically, or in response to a trigger event monitor the n-tier architecture 110 through the network 108. The workload characterization component 114 may collect workload data from the computing devices 104 and 106, while the dependency modeling component 116 may gather runtime data to understand system interactions and dependencies. The collected data may be processed by the cognitive restoration engine 118, which may leverage machine learning techniques to analyze patterns and anomalies. Based on this analysis, the cognitive restoration engine 118 may generate mitigation inferences, which may be used to guide restoration or rollback actions in case of system failures or performance degradation.

In some implementations, the output data generated by the cognitive restoration engine 118 may include one or more instructions configured to be executed by a mitigation engine to cause the mitigation engine to perform an action corresponding to the mitigation inference. This may facilitate automated or semi-automated resolution of detected issues, potentially reducing response times and minimizing human error in the failure management process.

The configuration of the rollback manager 112 may facilitate tailored approaches to mitigation in multi-tier application architectures. By leveraging the detailed baseline data from the workload characterization component and the comprehensive impact data from the dependency modeling component, the cognitive restoration engine can generate nuanced mitigation inferences. These inferences may recommend actions ranging from partial rollbacks of specific components to targeted restorations of individual tiers, rather than defaulting to full system restores. For example, if an issue is detected in a particular application tier, the system may recommend rolling back only the changes related to that tier, leaving other unaffected parts of the architecture intact.

This granular approach to mitigation may offer several advantages over current technology. Traditional restoration methods often rely on coarse-grained actions, such as full system rollbacks or complete restorations, which can be time-consuming and disruptive to overall system operations. In contrast, the rollback manager's ability to pinpoint issues and recommend targeted interventions may reduce downtime and minimize the impact on unaffected system components. Additionally, by preserving the state of unaffected tiers, the rollback manager may help maintain data integrity and consistency across the architecture, potentially avoiding the need for complex data reconciliation processes that often accompany full system restores.

Furthermore, the rollback manager's capability to adapt its mitigation strategies based on real-time dependency modeling and machine learning analysis may provide a more dynamic and context-aware approach to system recovery. As the n-tier architecture evolves and changes over time, the rollback manager can update its understanding of component interactions and dependencies. This ongoing learning process may allow the cognitive restoration engine to refine its mitigation recommendations, potentially improving the success rate of restoration actions and reducing the likelihood of cascading failures that can occur when interdependencies are not fully understood. By offering a more intelligent and flexible approach to system recovery, implementations described herein may help organizations maintain higher levels of system availability and reliability in complex, rapidly changing IT environments.

FIG. 1B is a data flow diagram associated with the computing environment 100. As shown, the workload characterization component 114 may be configured to determine, based on workload data 128 associated with the n-tier architecture 110, baseline data 132 indicative of one or more sets of baseline metrics corresponding to the n-tier architecture 110. As used herein, the term “workload data” may refer to information collected from the operation and usage of a multi-tier application architecture. This data may include metrics related to system performance, resource utilization, user interactions, and application behavior across various tiers of the architecture. Workload data may encompass information such as request/response patterns, transaction volumes, processing times, error rates, and resource consumption levels. It may also include logs of system events, user activities, and application-specific metrics that characterize the typical operational patterns and demands placed on the system. This data may be collected over time and may represent both normal operating conditions and periods of unusual activity or stress on the system.

The workload characterization component 114 may determine a set of baseline metrics based on these failure codes. The workload characterization component 114 may analyze various aspects of system behavior to generate comprehensive baseline metrics. In some implementations, the workload characterization component 114 may obtain and process data related to repeated HTTP requests, which can provide insights into potential system issues or user behavior patterns. For example, the workload characterization component 114 may examine the frequency and timing of repeated requests to determine if they are intentional or indicative of an anomaly within the system. This analysis may contribute to a set of baseline metrics that includes time-series data on request repetition patterns.

In some cases, the workload characterization component 114 may incorporate system performance metrics into its baseline data generation process. These metrics may include CPU utilization, memory usage, disk I/O, network traffic, and application-specific performance indicators. By tracking these metrics over time, the workload characterization component 114 may establish baseline performance levels for different parts of the n-tier architecture 110, enabling the detection of gradual performance degradation or sudden anomalies. The workload characterization component 114 may analyze trends in support tickets or user-reported issues, which can provide valuable context for understanding system health and user experience. This analysis may result in baseline metrics such as average ticket resolution time, frequency of specific issue types, or patterns in user-reported problems across different tiers of the architecture.

In some implementations, the workload characterization component 114 may generate baseline metrics related to database performance, such as query execution times, index efficiency, or data growth rates. These metrics may help identify potential bottlenecks or areas for optimization within the data tier of the n-tier architecture. The workload characterization component 114 may consider application-specific metrics that are relevant to the particular system being monitored. For example, in an e-commerce application, baseline metrics may include average order processing time, shopping cart abandonment rates, or peak transaction volumes during specific time periods. Network-related baseline metrics may be generated, such as latency between tiers, packet loss rates, or bandwidth utilization. These metrics may help identify communication issues or bottlenecks between different components of the n-tier architecture. In some cases, the workload characterization component 114 may establish baseline metrics for security-related aspects of the system, such as authentication failure rates, frequency of access attempts from unusual locations, or patterns in user session durations. By incorporating a diverse range of baseline metrics, the workload characterization component 114 may provide a comprehensive view of normal system behavior across all tiers of the n-tier architecture 110, enabling more accurate detection of anomalies and potential issues.

The dependency modeling component 116 may be configured to determine, based on the runtime data 130 associated with the n-tier architecture 110, impact data 134 associated with at least one dependency metric corresponding to the n-tier architecture 110. In some implementations, the dependency modeling component 116 may obtain the runtime data 130 by dynamically monitoring the n-tier architecture 110 during runtime.

The dependency modeling component 116 may obtain runtime data 130 through various methods of dynamic monitoring during the operation of the n-tier architecture 110. The runtime data 130 may include real-time information about system behavior, interactions between components, and performance metrics across different tiers of the architecture. In some implementations, the runtime data 130 may be collected through instrumentation of application code, middleware, and/or infrastructure components. This instrumentation may involve inserting monitoring hooks or agents that capture detailed information about method calls, database queries, network requests, and resource utilization. The runtime data 130 may be gathered from system logs, application performance monitoring (APM) tools, and network traffic analysis.

The runtime data 130 may show various aspects of system behavior, including, for example, transaction flows across different tiers and services, response times for individual components and end-to-end requests, resource consumption patterns (CPU, memory, I/O) for each tier, inter-service communication patterns and frequencies, error rates and types at different points in the system, scaling events and their impact on system performance, or changes in configuration or deployment during runtime, among other examples.

Using this runtime data 130, the dependency modeling component 116 may create a dynamic model of dependencies within the n-tier architecture 110. This dependency modeling process may involve several techniques. In some implementations, the dependency modeling component 116 may generate a graph-based representation. For example, the component interactions and dependencies may be modeled as a directed graph, where nodes represent services or components, and edges represent dependencies or communication paths. In some implementations, the dependency modeling component 116 may perform a statistical analysis: By analyzing patterns in the runtime data, the system may infer probabilistic dependencies between components, identifying correlations in performance or behavior. In some implementations, the dependency modeling component 116 may employ machine learning algorithms. For example, techniques such as clustering or anomaly detection may be applied to the runtime data to identify groups of related components or unusual dependency patterns. In some implementations, the dependency modeling component 116 may perform time-series analysis. By examining how dependencies change over time, the system may detect temporal patterns or shifts in the architecture's behavior.

The dependency modeling component 116 may continually and/or periodically update its model based on new runtime data, allowing it to adapt to changes in the system architecture or behavior. This dynamic modeling approach may enable the system to maintain an up-to-date understanding of complex, evolving n-tier architectures, facilitating more accurate impact analysis and targeted mitigation strategies. The dependency modeling component 116 may create a component interaction model associated with the n-tier architecture 110 based on the runtime data 130 and perform dependency modeling on the component interaction model to detect at least one set of dependency metrics associated with the n-tier architecture 110.

The baseline data 132 may represent a structured collection of metrics and indicators that characterize the normal operational state of the n-tier architecture 110. This data may be organized into multiple time slices, with each time slice containing sets of baseline metrics corresponding to different tiers or components of the architecture. For example, the baseline data 132 may include separate sets of metrics for the presentation tier, application tier, and data tier, allowing for granular analysis of system behavior at each level. Within each tier, the baseline data 132 may encompass various types of metrics, such as performance indicators, resource utilization levels, error rates, and user interaction patterns. The baseline data 132 may be arranged in a hierarchical or matrix-like structure, facilitating easy comparison of metrics across different time periods and system components. This organization may enable the cognitive restoration engine 118 to identify deviations from normal behavior and pinpoint the specific areas of the architecture that may require attention or mitigation actions.

The cognitive restoration engine 118 receives the baseline data 132 and impact data 134 as inputs. The cognitive restoration engine 118 may be configured to output, based on a machine learning component configured to process the baseline data 132 and the impact data 134, output data 136 indicative of a mitigation inference associated with the n-tier architecture 110. In some implementations, the cognitive restoration engine 118 may recommend a restoration action, a partial restoration action, a rollback action, or a partial rollback action based on the processed baseline data 132 and impact data 134.

The cognitive restoration engine 118 interfaces with a data store 120, which may be configured to store various types of data used by the components of the computing environment 100, including historical data, configuration data, and machine learning models. In some implementations, the cognitive restoration engine 118 may be trained based on historical data associated with at least one of the n-tier architecture 110 or another multi-tier application architecture having a configuration similarity with a configuration of the n-tier architecture 110.

The output data 136 generated by the cognitive restoration engine 118 may be provided to the mitigation engine 122 and/or the notification component 124. In some implementations, the output data 136 may include one or more instructions configured to be executed by the mitigation engine 122 to cause the mitigation engine 122 to perform an action corresponding to the mitigation inference. The mitigation engine 122 and notification component 124 connect to a feedback component 126. The feedback component 126 interfaces bidirectionally with the data store 120. This configuration may facilitate a continual learning process, where the outcomes of mitigation actions and system responses are fed back into the system to improve future decision-making.

The mitigation engine 122 may be configured to execute actions based on the output data 136 received from the cognitive restoration engine 118. In some implementations, the mitigation engine 122 may interpret the instructions contained within the output data 136 and translate them into specific system-level commands or operations. For example, if the output data 136 recommends a partial rollback of a specific tier, the mitigation engine 122 may initiate the necessary processes to revert that tier to a previous state while leaving other tiers unaffected.

The mitigation engine 122 may have access to various system management tools and APIs that allow it to interact with different components of the n-tier architecture 110. This may include capabilities such as stopping and starting services, modifying configuration files, deploying previous versions of software, or adjusting resource allocations. In some cases, the mitigation engine 122 may orchestrate complex sequences of actions across multiple tiers to implement the recommended mitigation strategy.

The mitigation engine 122 may incorporate safety checks and validation procedures to prevent further issues inadvertently caused by the actions it takes. For instance, the mitigation engine 122 may perform pre-execution checks to verify system readiness, monitor the progress of mitigation actions in real-time, and include rollback mechanisms in case a mitigation action needs to be aborted or reversed.

In some implementations, the mitigation engine 122 may operate in different modes, such as a fully automated mode where it executes actions without human intervention, or a semi-automated mode where it prepares actions for human approval before execution. The specific mode of operation may be configurable based on organizational policies or the criticality of the affected systems.

The notification component 124 may be configured to communicate information about system issues, mitigation recommendations, and actions taken to relevant stakeholders. In some implementations, the notification component 124 may generate and distribute alerts through various channels such as email, SMS, instant messaging platforms, or dedicated incident management systems. The notification component 124 may tailor its communications based on the severity of the issue, the role of the recipient, or the stage of the mitigation process, among other examples. For example, the notification component 124 may send brief, high-priority alerts to on-call engineers when a critical issue is first detected, followed by more detailed reports to management once the cognitive restoration engine 118 has generated mitigation recommendations.

In some cases, the notification component 124 may include interactive elements in its communications, allowing recipients to approve mitigation actions, request additional information, or escalate issues to higher-level support teams. This interactivity may facilitate rapid response to system issues, especially in scenarios where human oversight or decision-making is required before executing mitigation actions. The notification component 124 may maintain a log of communications sent, which can be used for auditing purposes or to analyze the effectiveness of the notification process over time. In some implementations, the notification component 124 may use machine learning techniques to optimize its communication strategies, such as determining the most effective timing and format of notifications for different types of issues and recipients.

Both the mitigation engine 122 and the notification component 124 may work in concert to ensure that system issues are addressed promptly and transparently. The mitigation engine 122 may provide real-time updates on the progress of mitigation actions to the notification component 124, which can then relay this information to relevant stakeholders. Similarly, any human input received through the notification component 124 may be used to guide or modify the actions taken by the mitigation engine 122.

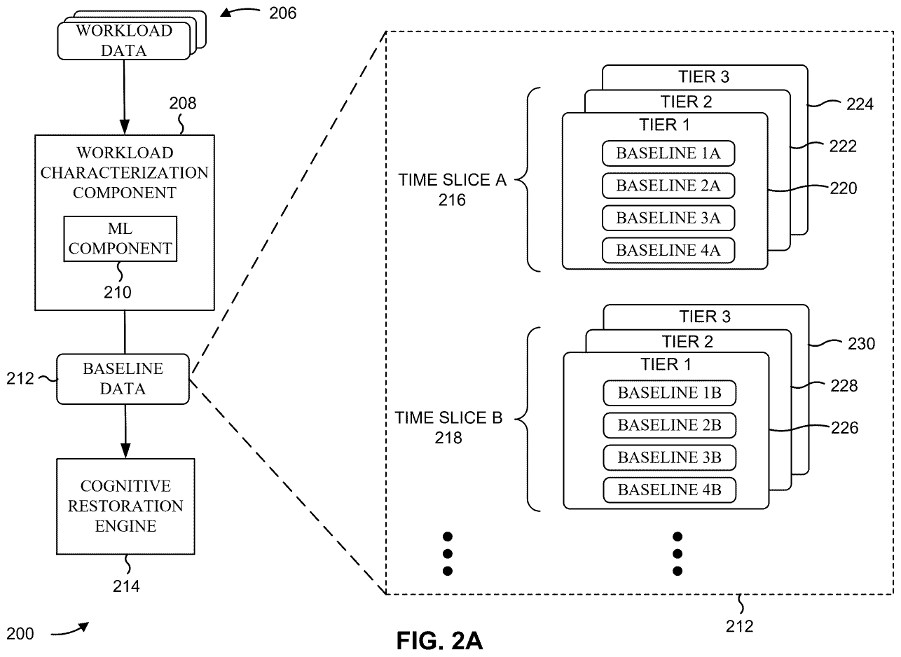

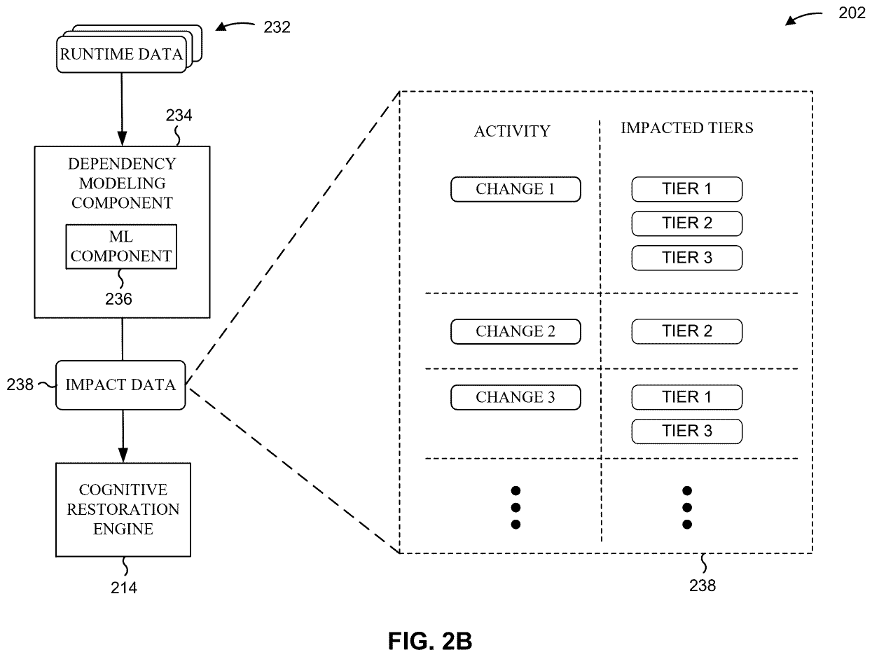

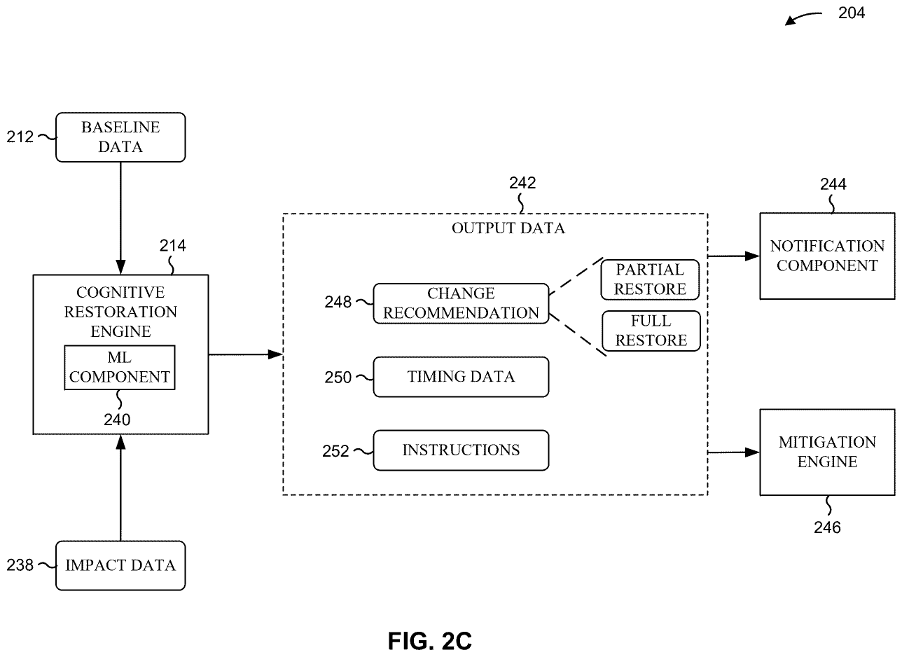

FIGS. 2A-2C are schematic diagrams showing examples 200, 202, and 204, respectively, associated with multi-tier application architecture failure management described herein. In some implementations, one or more aspects of the processes shown in FIGS. 2A-2C may be performed by the rollback manager 112 of FIG. 1A.

The example 200 includes workload data 206 that is provided as input to a workload characterization component 208. In some implementations, the workload characterization component 208 may be, be similar to, include, or be included in the workload characterization component 114 of FIG. 1A. The workload characterization component 208 includes a machine learning (ML) component 210 configured to process and analyze the workload data 206.

An ML component refers to hardware and/or software capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, large language models (LLMs), and/or support vector machines (SVMs), among other examples.

Two common types of problems in ML are classification problems and regression problems. Classification problems, also referred to as categorization problems, aim at classifying items into one of several category values (for example, is this object an apple or an orange). Regression algorithms aim at quantifying some items (for example, by providing a value that is a real number). ML components utilize training data to find correlations among identified features that affect the outcome. For example, ML components utilize features for analyzing the data to generate assessments. A feature is an individual measurable property of a phenomenon being observed. The concept of a feature is related to that of an explanatory variable used in statistical techniques such as linear regression. Choosing informative, discriminating, and independent features is important for effective operation of the ML component in pattern recognition, classification, and regression. Features may be of different types, such as numeric features, strings, and graphs.

ML components utilize the training data to find correlations among the identified features that affect the outcome or assessment. In some example embodiments, the training data includes labeled data, which is known data for one or more identified features and one or more outcomes. With the training data and the identified features, the ML component may be trained. The ML component appraises the value of the features as they correlate to the training data. The result of the training is the trained ML component. When the ML component is used to perform an assessment, new data is provided as an input to the trained ML component, and the ML component generates an assessment as output.

ML techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the ML technique used. For example, in a genetic or evolutionary algorithm, the values for the models that are most successful in predicting the desired outputs are used to develop values for models to use during the subsequent epoch, which may include random variation/mutation to provide additional data points.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

ML models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the realm of natural language processing (NLP), ML training software can employ a learning paradigm focused on human preferences to better align pretrained and instruction-tuned generative language models with human values. This process involves the ML training software collecting extensive data, where each data point comprises a context, pairs of continuations of the context (generations), and a pairwise human preference indicating the superior generation. Subsequently, the ML training software learns to generate optimal continuations for a given context based on the collected data.

In some cases, the ML training software may employ reinforcement learning (RL), which is a method of training neural networks that may be used, for example, for training LLMs. Similar to human learning, RL trains neural networks through trial and error. Specifically, the neural network produces an output, receives feedback regarding this output, and then learns from the feedback. For instance, when finetuning a language model using reinforcement learning from human feedback (RLHF), the language model generates text and receives a score or reward from a human annotator, which reflects the quality of the text. The AI training software then employs RL to finetune the language model to generate outputs with high scores.

Reinforcement learning proves to be an advantageous and promising learning algorithm for neural networks because it allows learning from non-differentiable signals, which are incompatible with supervised learning. This capability enables the AI training software to learn from arbitrary feedback on a neural network's output. In the case of RLHF, the outputs generated by a language model can be scored according to any predefined principle. The AI training software then uses RL to learn from these scores, regardless of their definition.

Problems addressed via RL are typically structured in a consistent format. Specifically, an agent interacts with an environment, maintaining a state within this environment and producing actions that can alter the current state. As the agent interacts with the environment, it can receive both positive and negative rewards for its actions. The agent's objective is to maximize the rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a “policy model”) takes a state as input and outputs a probability distribution over possible actions. Given this output, a decision can be made for the action to be taken from a current state, and the transition is then a function that outputs the next state based upon the prior state and chosen action. Using these components, the agent can interact with the environment in an iterative fashion to generate a trained policy

The workload data 206 may include various types of information associated with the operation of the multi-tier application architecture. In some implementations, the workload data 206 may include failure codes associated with HTTP request response failures corresponding to at least one tier of the multi-tier application architecture. The workload data 206 may further include repeat request data, performance metric data, and ticket trend data associated with the multi-tier application architecture.

The workload characterization component 208 may be configured to determine, based on the workload data 206, baseline data 212 indicative of one or more sets of baseline metrics corresponding to the multi-tier application architecture. The ML component 210 within the workload characterization component 208 may facilitate the analysis of complex patterns and trends in the workload data 206 to generate meaningful baseline metrics.

The baseline data 212 output by the workload characterization component 208 may be organized into multiple time slices, including time slice A 216 and time slice B 218, which contain sets of baseline metrics organized by tier of the n-tier architecture. This organization may facilitate a comprehensive analysis of system behavior across different components and time periods. In some implementations, the sets of baseline metrics may include time-series HTTP request response metrics, time-series repeat request metrics, time-series performance metrics, and time-series ticket trend metrics.

Each time slice in the baseline data 212 may comprise multiple tiers containing sets of baseline metrics. For example, time slice A 216 includes sets of baseline metrics 220, 222, and 224, while time slice B 218 includes sets of baseline metrics 226, 228, and 230. The set of baseline metrics 220 may include baseline 1A through baseline 4A, representing various aspects of system performance or behavior. Similarly, the set of baseline metrics 226 may include baseline 1B through baseline 4B. This structure may facilitate detailed tracking of system metrics across different tiers and time periods, enabling the detection of patterns, trends, and potential anomalies.

In some implementations, the baseline data 212 may be determined at different stages of the application lifecycle. For instance, a first portion of the baseline data may be determined prior to deployment of an application corresponding to the multi-tier application architecture. A second portion may be determined subsequent to deployment of the application, and a third portion may be determined during a failure corresponding to the application. This multi-stage approach may provide a comprehensive view of system behavior across different operational states, allowing for more accurate detection of deviations from normal behavior and facilitating targeted mitigation strategies.

The baseline data 212 output by the workload characterization component 208 is provided to a cognitive restoration engine 214. In some implementations, the cognitive restoration engine 214 may be similar to or include the cognitive restoration engine 118 of FIG. 1A.

The system example 202, shown in FIG. 2B, includes runtime data 232 that is provided as input to a dependency modeling component 234. In some implementations, the dependency modeling component 234 may be similar to or include the dependency modeling component 116 of FIG. 1A. The dependency modeling component 234 contains an ML component 236 that processes the runtime data 232.

The runtime data 232 may be obtained by dynamically monitoring the multi-tier application architecture during runtime. This dynamic monitoring may capture real-time information about system interactions, performance, and dependencies across different tiers and components of the architecture.

The dependency modeling component 234 may be configured to determine, based on the runtime data 232, impact data 238 associated with at least one dependency metric corresponding to the multi-tier application architecture. The ML component 236 within the dependency modeling component 234 may facilitate the analysis of complex system interactions and the detection of dependency patterns that may not be immediately apparent through manual analysis.

The dependency modeling component 234 generates impact data 238, which is provided to the cognitive restoration engine 214. The impact data 238 includes information about activities and their corresponding impacted tiers in the system. As shown in the expanded view of the impact data 238, it contains a mapping between different changes (CHANGE 1, CHANGE 2, CHANGE 3, etc.) and their associated impacted tiers (TIER 1, TIER 2, TIER 3, etc.).

The impact data 238 may provide a comprehensive representation of how various changes or activities within the multi-tier application architecture affect different tiers and components of the system. This data may be structured as a matrix or mapping that correlates specific changes or events with their corresponding impacts across the architecture. For example, the impact data 238 may include change propagation patterns that show how a change in one tier cascades through the system. For instance, a code update in the application tier (TIER 2) may impact both the presentation tier (TIER 1) and the database tier (TIER 3) due to changes in data structures or API interfaces. The impact data 238 may include performance impact metrics that quantify how certain changes affect system performance. For example, CHANGE 1 may result in a 20% increase in response time for TIER 1, a 15% increase in CPU utilization for TIER 2, and a 30% increase in database queries for TIER 3. The impact data 238 may include dependency chains that indicate dependency relationships between components. For instance, CHANGE 2 may directly impact TIER 2, but due to tight coupling between services, it may indirectly affect TIER 1 through altered API responses.

The impact data 238 may include resource utilization changes. For example, the impact data may track how system resources are affected by various changes. For example, CHANGE 3 may lead to a 25% increase in memory usage in TIER 1 and a 40% increase in network bandwidth consumption between TIER 2 and TIER 3. The impact data 238 may include error rate correlations that associate changes with fluctuations in error rates across different tiers. For instance, CHANGE 4 may correspond to a 5% increase in HTTP 500 errors in TIER 1 and a 10% increase in database timeout errors in TIER 3. The impact data 238 may include user experience metrics that include information on how changes affect end-user experience. For example, CHANGE 5 may be associated with a 10% increase in page load time for TIER 1 and a 15% decrease in successful transactions in TIER 2.

The impact data 238 may include scalability implications. For example, the impact data may reflect how changes affect the system's ability to scale. For instance, CHANGE 6 may show that TIER 2 experiences performance degradation when user load increases beyond a certain threshold after the change. The impact data 238 may include security posture alterations that indicate how changes affect the security stance of different tiers. For example, CHANGE 7 may be associated with an increase in potential vulnerabilities in TIER 1 and a need for additional authentication measures in TIER 2.

By providing this detailed impact data, the dependency modeling component 234 may enable the cognitive restoration engine 214 to make more informed decisions about system restoration and mitigation strategies.

In some implementations, the dependency modeling component 234 may create a component interaction model associated with the multi-tier application architecture based on the runtime data 232. The dependency modeling component 234 may perform dependency modeling on the component interaction model to detect at least one set of dependency metrics associated with the multi-tier application architecture. In some implementations, the dependency modeling component 234 may create an impact matrix associated with the multi-tier application architecture based on the runtime data 232. The impact matrix may indicate, for each activity of one or more monitored activities, a set of impacted tiers of the multi-tier application architecture.

The example 204, shown in FIG. 2C, includes the cognitive restoration engine 214 that receives baseline data 212 and impact data 238 as inputs. The cognitive restoration engine 214 contains an ML component 240 configured to process the received data.

The cognitive restoration engine 214 may be configured to output, based on the ML component 240 processing the baseline data 212 and the impact data 238, output data 242 indicative of a mitigation inference associated with the multi-tier application architecture. The ML component 240 may employ various machine learning techniques to analyze the complex relationships between baseline system behavior and the impact of changes or issues on different tiers of the architecture.

The cognitive restoration engine 214 may serve as a central processing unit for analyzing and synthesizing the baseline data 212 and impact data 238 to generate intelligent mitigation strategies for the multi-tier application architecture. The cognitive restoration engine 214 may utilize ML algorithms and heuristics to interpret complex patterns and relationships within the input data, enabling it to make informed decisions about system restoration and optimization.

The ML component 240 within the cognitive restoration engine 214 may employ a variety of machine learning techniques to process and analyze the input data. These techniques may include supervised learning algorithms, unsupervised learning methods, and/or reinforcement learning approaches. In some implementations, the ML component 240 may utilize ensemble learning, combining multiple models such as decision trees, neural networks, and support vector machines to improve the accuracy and robustness of its predictions.

The cognitive restoration engine 214 may first preprocess the baseline data 212 and impact data 238, normalizing and transforming the data as needed to ensure compatibility with the ML component 240. This preprocessing step may involve techniques such as feature scaling, dimensionality reduction, and handling of missing or anomalous data points. Once the data is prepared, the ML component 240 may analyze it using various algorithms. For example, the ML component 240 may employ clustering algorithms to identify groups of related issues or changes, classification algorithms to categorize different types of system behaviors, or regression algorithms to predict the potential impact of proposed changes or mitigation actions.

The cognitive restoration engine 214 may incorporate a temporal aspect into its analysis. The cognitive restoration engine 214 may use time series analysis techniques to identify trends, seasonality, and cyclical patterns in the baseline and impact data. This temporal awareness may allow the cognitive restoration engine 214 to distinguish between transient anomalies and more persistent issues, potentially improving the accuracy of its mitigation recommendations. In some implementations, the cognitive restoration engine 214 may utilize a feedback loop to improve its performance. The outcomes of previous mitigation actions may be fed back into the system, allowing the ML component 240 to refine its models and improve the accuracy of future recommendations.

The cognitive restoration engine 214 may employ explainable AI techniques to provide transparency into its decision-making process. This may involve generating detailed explanations for its mitigation inferences, including the factors that influenced the decision, the confidence level of the recommendation, and potential alternative strategies.

Based on the analysis performed by the ML component 240, the cognitive restoration engine 214 may generate a range of potential mitigation strategies. These strategies may be ranked based on their predicted effectiveness, potential risks, and alignment with predefined system performance goals. The engine may consider factors such as the criticality of affected services, the potential impact on user experience, and the resource requirements for implementing each strategy.

In some cases, the cognitive restoration engine 214 may simulate the potential outcomes of different mitigation strategies using the baseline and impact data. This simulation capability may allow the engine to predict the effects of proposed changes before they are implemented in the live system, potentially reducing the risk of unintended consequences.

The output data 242 generated by the cognitive restoration engine 214 may include not only the recommended mitigation actions but also supporting evidence and rationale for these recommendations. This comprehensive output may enable system administrators and other stakeholders to make informed decisions about how to address issues in the multi-tier application architecture.

The output data 242 generated by the cognitive restoration engine 214 includes a change recommendation 248, which can specify partial restore or full restore options. The output data 242 also includes timing data 250 and instructions 252. The change recommendation 248 may include recommendations for restoration actions, partial restoration actions, rollback actions, or partial rollback actions based on the processed baseline data 212 and impact data 238.

The output data 242 is provided to two components: a notification component 244 and a mitigation engine 246. The notification component 244 may be configured to notify administrators or other system components about recommended changes. The notification component 244 may generate and distribute alerts through various channels such as email, SMS, or dedicated incident management systems.

The mitigation engine 246 receives the instructions 252 and may be configured to execute actions based on those instructions to implement the recommended changes. In some implementations, the instructions 252 may be configured to be executed by the mitigation engine 246 to cause the mitigation engine 246 to perform an action corresponding to the mitigation inference.

This configuration may facilitate efficient failure management by enabling the system to quickly identify deviations from normal behavior, understand the scope of impact across different tiers, and recommend targeted actions to restore system functionality. The integration of machine learning components throughout the process may allow for continual improvement in the accuracy and effectiveness of the failure management system over time.

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The computing environment 300 contains an example of an environment for the execution of at least some of the computer code involved in performing the inventive methods, such as a rollback manager, shown in block 350. In addition to block 350, the computing environment 300 includes, for example, a computer 301, a WAN 302, an end user device (EUD) 303, a remote server 304, a public cloud 305, and a private cloud 306. In this embodiment, the computer 301 includes a processor set 310 (including processing circuitry 320 and a cache 321), a communication fabric 311, a volatile memory 312, persistent storage 313 (including an operating system 322 and a block 350, as identified above), a peripheral device set 314 (including a user interface (UI) device set 323, storage 324, and an Internet of Things (IoT) sensor set 325), and a network module 315. The remote server 304 includes a remote database 330. The public cloud 305 includes a gateway 340, a cloud orchestration module 341, a host physical machine set 342, a virtual machine set 343, and a container set 344.

The computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as a remote database 330. As is well understood in the art of computer technology, and depending upon the technology, performance of a computer-implemented method may be distributed among multiple computers and/or between multiple locations. On the other hand, in this presentation of the computing environment 300, detailed discussion is focused on a single computer, specifically the computer 301, to keep the presentation as simple as possible. The computer 301 may be located in a cloud, even though it is not shown in a cloud in FIG. 3. On the other hand, the computer 301 is not required to be in a cloud except to any extent as may be affirmatively indicated.

The processor set 310 includes one or more computer processors of any type now known or to be developed in the future. The processing circuitry 320 may be distributed over multiple packages, for example, multiple, coordinated integrated circuit chips. The processing circuitry 320 may implement multiple processor threads and/or multiple processor cores. The cache 321 is memory that is located in the processor chip package(s) and is typically used for data or code that should be available for rapid access by the threads or cores running on the processor set 310. Cache memories are typically organized into multiple levels depending upon relative proximity to the processing circuitry. Alternatively, some, or all, of the cache for the processor set may be located “off chip.” In some computing environments, the processor set 310 may be designed for working with qubits and performing quantum computing.

Computer readable program instructions are typically loaded onto the computer 301 to cause a series of operational steps to be performed by the processor set 310 of the computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 321 and the other storage media discussed below. The program instructions, and associated data, are accessed by the processor set 310 to control and direct performance of the inventive methods. In the computing environment 300, at least some of the instructions for performing the inventive methods may be stored in the block 350 in persistent storage 313.

The communication fabric 311 is the signal conduction path that allows the various components of the computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 312 is any type of volatile memory now known or to be developed in the future. Examples include dynamic type RAM or static type RAM. Typically, the volatile memory 312 is characterized by random access, but this is not required unless affirmatively indicated. In the computer 301, the volatile memory 312 is located in a single package and is internal to the computer 301, but, alternatively or additionally, the volatile memory 312 may be distributed over multiple packages and/or located externally with respect to the computer 301.

The persistent storage 313 is any form of non-volatile storage for computers that is now known or to be developed in the future. The non-volatility of this storage means that the stored data is maintained regardless of whether power is being supplied to the computer 301 and/or directly to the persistent storage 313. The persistent storage 313 may be an ROM, but typically at least a portion of the persistent storage allows writing of data, deletion of data and re-writing of data. Some familiar forms of persistent storage include magnetic disks and solid state storage devices. The operating system 322 may take several forms, such as various known proprietary operating systems or open source Portable Operating System Interface-type operating systems that employ a kernel. The code included in block 350 typically includes at least some of the computer code involved in performing the inventive methods.

The peripheral device set 314 includes the set of peripheral devices of the computer 301. Data communication connections between the peripheral devices and the other components of the computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 323 may include components such as a display screen, speaker, microphone, wearable devices (such as goggles and smart watches), keyboard, mouse, printer, touchpad, game controllers, and haptic devices. The storage 324 is external storage, such as an external hard drive, or insertable storage, such as an SD card. The storage 324 may be persistent and/or volatile. In some embodiments, the storage 324 may take the form of a quantum computing storage device for storing data in the form of qubits. In embodiments where the computer 301 is required to have a large amount of storage (for example, where the computer 301 locally stores and manages a large database) then this storage may be provided by peripheral storage devices designed for storing very large amounts of data, such as a storage area network (SAN) that is shared by multiple, geographically distributed computers. The IoT sensor set 325 is made up of sensors that can be used in Internet of Things applications. For example, one sensor may be a thermometer and another sensor may be a motion detector.

The network module 315 is the collection of computer software, hardware, and firmware that allows the computer 301 to communicate with other computers through the WAN 302. The network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 315 are performed on the same physical hardware device. In other embodiments (for example, embodiments that utilize software-defined networking (SDN)), the control functions and the forwarding functions of the network module 315 are performed on physically separate devices, such that the control functions manage several different network hardware devices. Computer readable program instructions for performing the inventive methods can typically be downloaded to the computer 301 from an external computer or external storage device through a network adapter card or network interface included in the network module 315.

The WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The EUD 303 is any computer system that is used and controlled by an end user (for example, a customer of an enterprise that operates the computer 301) and may take any of the forms discussed above in connection with the computer 301. The EUD 303 typically receives helpful and useful data from the operations of computer 301. For example, in a hypothetical case where the computer 301 is designed to provide a recommendation to an end user, this recommendation would typically be communicated from the network module 315 of the computer 301 through the WAN 302 to the EUD 303. In this way, the EUD 303 can display, or otherwise present, the recommendation to an end user. In some embodiments, the EUD 303 may be a client device, such as thin client, heavy client, mainframe computer, desktop computer and so on.

The remote server 304 is any computer system that serves at least some data and/or functionality to the computer 301. The remote server 304 may be controlled and used by the same entity that operates the computer 301. The remote server 304 represents the machine(s) that collect and store helpful and useful data for use by other computers, such as the computer 301. For example, in a hypothetical case where the computer 301 is designed and programmed to provide a recommendation based on historical data, then this historical data may be provided to the computer 301 from the remote database 330 of the remote server 304.

The public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 305 is performed by the computer hardware and/or software of the cloud orchestration module 341. The computing resources provided by the public cloud 305 are typically implemented by virtual computing environments that run on various computers making up the computers of the host physical machine set 342, which is the universe of physical computers in and/or available to the public cloud 305. The virtual computing environments (VCEs) typically take the form of virtual machines from the virtual machine set 343 and/or containers from the container set 344. It is understood that these VCEs may be stored as images and may be transferred among and between the various physical machine hosts, either as images or after instantiation of the VCE. The cloud orchestration module 341 manages the transfer and storage of images, deploys new instantiations of VCEs and manages active instantiations of VCE deployments. The gateway 340 is the collection of computer software, hardware, and firmware that allows the public cloud 305 to communicate through the WAN 302.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 306 is similar to the public cloud 305, except that the computing resources are only available for use by a single enterprise. While the private cloud 306 is depicted as being in communication with the WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 305 and the private cloud 306 are both part of a larger hybrid cloud.

FIG. 4 is a diagram of example components of a device 400, which may implement one or more components of the computing environment 100. In some implementations, the device 400 may be, be similar to, include, or be included in the computer 301 shown in FIG. 3. The device 400 may be, be similar to, include, or be included in, an apparatus for performing one or more methods, processes, algorithms, operations, tasks, and/or techniques, as described herein. The device 400 may be, be similar to, include, or be included in, a computing device, a laptop, a workstation, a server device, or a personal computer, among other examples. As shown in FIG. 4, device 400 may include a bus 410 that interconnects various components or units, such as a processor 420, a memory 430, a storage component 440, an input component 450, an output component 460, and a communication component 470.

The processor 420 may be a central processing unit, such as a microprocessor, and may include single or multiple processors having single or multiple processing cores. The processor 420 may include another type of device, or multiple devices, configured for manipulating or processing information. For example, the processor 420 may include multiple processors interconnected in one or more manners, including hardwired or networked. The operations of the processor 420 may be distributed across multiple devices or units that can be coupled directly or across a local area or other suitable type of network. The processor 420 may include a cache, or cache memory, for local storage of operating data or instructions. The processor 420 is implemented in hardware, firmware, or a combination of hardware and software. In some implementations, the processor 420 includes one or more processors capable of being programmed to perform a function. In some implementations, the processor 420 may be, be similar to, include, or be included in processor set 310 shown in FIG. 3.

The memory 430 includes one or more memory components, which may each be volatile memory or non-volatile memory. The memory 430 may include non-transitory memory. The volatile memory can be RAM (e.g., a DRAM module, such as DDR SDRAM). The non-volatile memory of the memory 430 may be a disk drive, a solid state drive, flash memory, or phase-change memory. In some implementations, the memory 430 may be distributed across multiple devices. For example, the memory 430 may include network-based memory or memory in multiple clients or servers performing the operations of those multiple devices.

The memory 430 may include data for access by the processor 420. For example, the memory 430 may include executable instructions, application data, or an operating system, among other examples. The executable instructions may include one or more application programs, which may be loaded or copied, in whole or in part, from non-volatile memory to volatile memory to be executed by the processor 420. For example, the executable instructions may include instructions for performing techniques described in this disclosure. In some implementations, the application data may include functional programs, such as a computational programs, analytical programs, database programs, and so on. The operating system may be, for example, Microsoft Windows®, Mac OS X®, or Linux®; an operating system for a mobile device, such as a smartphone or tablet device; or an operating system for a non-mobile device, such as a mainframe computer.

The storage component 440 stores information and/or software related to the operation of the device 400. For example, the storage component 440 may include a hard disk drive, a magnetic disk drive, an optical disk drive, a solid state disk drive, a compact disc, a digital versatile disc, and/or another type of non-transitory computer-readable medium. The storage component 440 may be, be similar to, include, or be included in, the memory 430.

The input component 450 enables the device 400 to receive input, such as user input and/or sensed inputs. For example, the input component 450 may include a touch screen, a keyboard, a keypad, a mouse, a button, a microphone, a switch, a sensor, a global positioning system component, an accelerometer, a gyroscope, and/or an actuator. The output component 460 enables the device 400 to provide output, such as via a display, a speaker, and/or one or more light-emitting diodes. The communication component 470 enables the device 400 to communicate with other devices, such as via a wired connection and/or a wireless connection. For example, the communication component 470 may include a receiver, a transmitter, a transceiver, a modem, a network interface card, and/or an antenna.

The device 400 may perform one or more processes described herein. For example, a non-transitory computer-readable medium (e.g., the memory 430 and/or the storage component 440) may store a set of instructions (e.g., one or more instructions, code, software code, and/or program code) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

In the description herein, sentences describing a system, an apparatus, or a device as taking an action (such as performing, determining, initiating, receiving, calculating, deciding, computing, processing, etc.) are to be understood that some appropriate component of the system, apparatus, or device as taking the action. Such components may refer to hardware and/or software configured to take the action.

The terms “processor,” “processing circuitry,” “processor set,” or “controller” may refer to one or more processors. For example, reference to “a/the processor,” “a/the processor set,” or the like (in the singular) should be understood to refer to any one or more of the processors described in connection with FIGS. 3 and 4, such as a single processor or a combination of multiple different processors. Reference to “one or more processors” should be understood to refer to any one or more of the processors described in connection with FIGS. 3 and 4.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIGS. 3 and 4. For example, operation described as being performed by one or more memories can be performed by the same subset of the one or more memories or different subsets of the one or more memories. Additionally or alternatively, in some examples, one or more of the processors may be preconfigured to perform various functions or operations described herein without requiring configuration by software.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

An “engine” refers to a component constructed, programmed, configured, or otherwise adapted to perform a specific function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out. s used herein, the term “model” encompasses its plain and ordinary meaning. A model may include, among other things, one or more engines which receive an input and compute an output based on the input.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

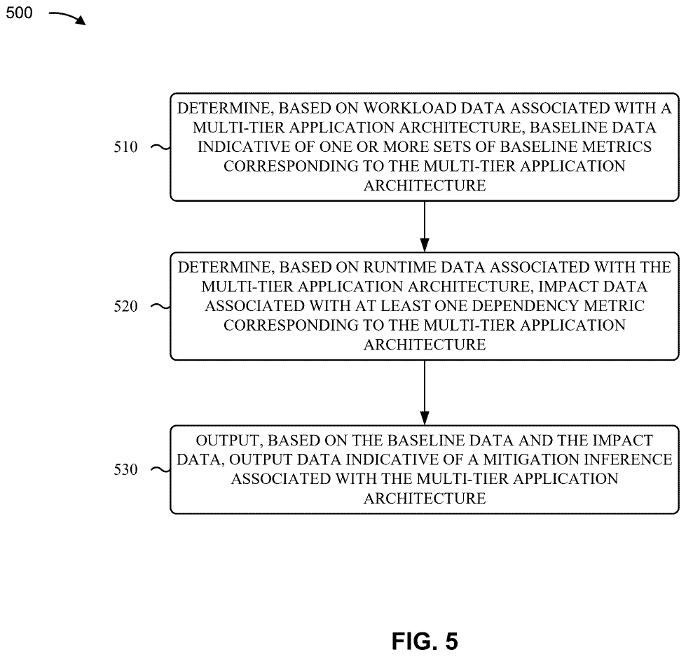

To further describe some implementations in greater detail, reference is next made to examples of techniques which may be performed by or using an AI system as described herein. FIG. 5 is a flowchart of an example of a technique 500 associated with multi-tier application architecture failure management. The technique 500 can be executed using computing devices, such as the systems, hardware, and software described with respect to FIGS. 1A-4. The technique 500 can be performed, for example, by executing a machine-readable program or other computer-executable instructions, such as routines, instructions, programs, or other code. The steps, or operations, of the technique 500, or another technique, method, process, or algorithm described in connection with the implementations disclosed herein can be implemented directly in hardware, firmware, software executed by hardware, circuitry, or a combination thereof.

For simplicity of explanation, the technique 500 is depicted and described herein as a series of steps or operations. However, the steps or operations of the technique 500 can occur in various orders and/or concurrently. Additionally, other steps or operations not presented and described herein may be used. Furthermore, not all illustrated steps or operations may be required to implement a technique in accordance with the disclosed subject matter.

At 510, the technique 500 may include determining, based on workload data associated with a multi-tier application architecture, baseline data indicative of one or more sets of baseline metrics corresponding to the multi-tier application architecture. In some implementations, this step may be performed by a workload characterization component, such as the workload characterization component 114 described in connection with FIG. 1A. The workload data may include various types of information associated with the operation of the multi-tier application architecture, such as failure codes associated with HTTP request response failures, repeat request data, performance metric data, and ticket trend data.

In some implementations, determining the baseline data may include obtaining failure codes associated with HTTP request response failures corresponding to at least one tier of the multi-tier application architecture. Based on these failure codes, a set of baseline metrics may be determined, which may include at least one time-series HTTP request response metric. This approach may facilitate the identification of patterns or anomalies in system behavior related to HTTP interactions.

The determination of baseline data may also involve obtaining repeat request data associated with the multi-tier application architecture. Based on this data, another set of baseline metrics may be determined, which may include at least one time-series repeat request metric. This information may be valuable for understanding user behavior patterns and identifying potential system issues that lead to repeated requests.

In some implementations, the baseline data determination process may include obtaining performance metric data associated with the multi-tier application architecture. This data may be used to determine a set of baseline metrics that includes at least one time-series performance metric. Performance metrics may provide insights into system health and resource utilization across different tiers of the architecture.

The technique 500 may also involve obtaining ticket trend data associated with the multi-tier application architecture as part of the baseline data determination process. Based on this data, a set of baseline metrics may be determined that includes at least one time-series ticket trend metric. Analyzing ticket trends may help identify recurring issues or areas of the system that frequently require attention.

In some implementations, the one or more sets of baseline metrics may be organized into multiple consecutive time slices. For each time slice, there may be a plurality of sets of baseline metrics, with each set corresponding to a respective tier of the multi-tier application architecture. This organization may facilitate the analysis of system behavior across different tiers and time periods, enabling the detection of trends or anomalies that may not be apparent when looking at a single point in time.

At 520, the technique 500 may include determining, based on runtime data associated with the multi-tier application architecture, impact data associated with at least one dependency metric corresponding to the multi-tier application architecture. In some implementations, this step may be performed by a dependency modeling component, such as the dependency modeling component 116 described in connection with FIG. 1A. The runtime data may be obtained by dynamically monitoring the multi-tier application architecture during runtime, providing real-time information about system behavior and interactions.

In some implementations, determining the impact data may involve creating a component interaction model associated with the multi-tier application architecture based on the runtime data. Dependency modeling may then be performed on this component interaction model to detect at least one set of dependency metrics associated with the multi-tier application architecture. This approach may facilitate a deeper understanding of how different components and tiers of the system interact and depend on each other.

Alternatively or additionally, the impact data determination process may include creating an impact matrix associated with the multi-tier application architecture based on the runtime data. This impact matrix may indicate, for each activity of one or more monitored activities, a set of impacted tiers of the multi-tier application architecture. Such a matrix may provide a clear visualization of how changes or issues in one part of the system can affect other areas.

At 530, the technique 500 may include outputting, based on a machine learning component configured to process the baseline data and the impact data, output data indicative of a mitigation inference associated with the multi-tier application architecture. In some implementations, this step may be performed by a cognitive restoration engine, such as the cognitive restoration engine 118 described in connection with FIG. 1A. The machine learning component may analyze patterns and relationships in the baseline and impact data to generate intelligent mitigation strategies.

In some implementations, determining the mitigation inference may involve recommending one or more actions, such as a restoration action, a partial restoration action, a rollback action, or a partial rollback action. These recommendations may be based on the processed baseline data and impact data, taking into account the current state of the system and the potential impacts of different mitigation strategies.

The machine learning component used in the technique 500 may be trained based on historical data associated with the multi-tier application architecture or another multi-tier application architecture having a configuration similarity with the current architecture. This training process may enhance the accuracy and effectiveness of the mitigation inferences over time as the system learns from past experiences and outcomes.

In some implementations, outputting the output data may include generating one or more instructions configured to be executed by a mitigation engine. These instructions may cause the mitigation engine to perform an action corresponding to the mitigation inference, facilitating automated or semi-automated resolution of detected issues in the multi-tier application architecture.

The technique 500 may be applied at various stages of the application lifecycle. For example, portions of the baseline data and impact data may be determined prior to deployment of an application corresponding to the multi-tier application architecture, subsequent to deployment, and during a failure corresponding to the application. This multi-stage approach may provide a comprehensive view of system behavior across different operational states.

In some implementations, the technique 500 may include additional steps or variations of the described steps. For example, the process may involve continually, periodically, or in response to a trigger event updating the baseline data and impact data as the system evolves over time. This ongoing monitoring and analysis may help maintain an up-to-date understanding of the system's behavior and dependencies.

The technique 500 may also include steps for validating and refining the mitigation inferences. For instance, after implementing a recommended action, the system may monitor the results and use this feedback to improve future recommendations. This iterative process may enhance the accuracy and effectiveness of the failure management system over time.

According to an aspect of the disclosure, there is provided a computer-implemented method. The method includes determining baseline data indicative of one or more sets of baseline metrics corresponding to a multi-tier application architecture based on workload data associated with the multi-tier application architecture. The method also includes determining impact data associated with at least one dependency metric corresponding to the multi-tier application architecture based on runtime data associated with the multi-tier application architecture. Additionally, the method includes outputting output data indicative of a mitigation inference associated with the multi-tier application architecture based on a machine learning component configured to process the baseline data and the impact data. This method improves the efficiency and accuracy of failure management in complex multi-tier application architectures by utilizing a data-driven approach that combines workload characterization, dependency modeling, and machine learning techniques. Additionally, the method reduces downtime and resource waste by enabling more targeted and precise mitigation strategies compared to traditional full-system rollback approaches.

In embodiments, determining the baseline data can include obtaining failure codes associated with HTTP request response failures corresponding to at least one tier of the multi-tier application architecture and determining a set of baseline metrics based on the failure codes. The set of baseline metrics can include at least one time-series HTTP request response metric. This approach has the technical effect of enabling the identification of patterns or anomalies in system behavior related to HTTP interactions, which can be crucial for understanding and addressing issues in web-based applications.

In embodiments, determining the baseline data can include obtaining repeat request data associated with the multi-tier application architecture and determining a set of baseline metrics based on the repeat request data. The set of baseline metrics can include at least one time-series repeat request metric. This feature has the technical effect of providing insights into user behavior patterns and identifying potential system issues that lead to repeated requests, which can help optimize system performance and user experience.

In embodiments, determining the baseline data can include obtaining performance metric data associated with the multi-tier application architecture and determining a set of baseline metrics based on the performance metric data. The set of baseline metrics can include at least one time-series performance metric. This approach has the technical effect of providing insights into system health and resource utilization across different tiers of the architecture, enabling more effective resource allocation and performance optimization.

In embodiments, determining the baseline data can include obtaining ticket trend data associated with the multi-tier application architecture and determining a set of baseline metrics based on the ticket trend data. The set of baseline metrics can include at least one time-series ticket trend metric. This feature has the technical effect of identifying recurring issues or areas of the system that frequently require attention, which can help prioritize maintenance efforts and improve overall system reliability.

In embodiments, the one or more sets of baseline metrics can comprise, for each time slice of a plurality of consecutive time slices, a plurality of sets of baseline metrics. Each set of baseline metrics of the plurality of sets of baseline metrics can correspond to a respective tier of the multi-tier application architecture. This organization has the technical effect of facilitating the analysis of system behavior across different tiers and time periods, enabling the detection of trends or anomalies that may not be apparent when looking at a single point in time.

In embodiments, determining the impact data can include obtaining the runtime data by dynamically monitoring the multi-tier application architecture during runtime, creating a component interaction model associated with the multi-tier application architecture based on the runtime data, and performing dependency modeling on the component interaction model to detect at least one set of dependency metrics associated with the multi-tier application architecture. This approach has the technical effect of providing a deeper understanding of how different components and tiers of the system interact and depend on each other, which is crucial for accurate impact assessment and targeted mitigation strategies.

In embodiments, determining the impact data can include obtaining the runtime data by dynamically monitoring the multi-tier application architecture during runtime and creating an impact matrix associated with the multi-tier application architecture based on the runtime data. The impact matrix can indicate, for each activity of one or more monitored activities, a set of impacted tiers of the multi-tier application architecture. This feature has the technical effect of providing a clear visualization of how changes or issues in one part of the system can affect other areas, enabling more informed decision-making in failure management.

In embodiments, the method can include determining the mitigation inference based on the baseline data and the impact data. Determining the mitigation inference can include recommending a restoration action, recommending a partial restoration action, recommending a rollback action, or recommending a partial rollback action. This approach has the technical effect of providing tailored mitigation strategies based on the specific nature and scope of detected issues, potentially reducing unnecessary disruptions to unaffected parts of the system.

In embodiments, the method can include training the machine learning component based on historical data associated with at least one of the multi-tier application architecture or another multi-tier application architecture having a configuration similarity with a configuration of the multi-tier application architecture. This feature has the technical effect of improving the accuracy and effectiveness of the mitigation inferences over time as the system learns from past experiences and outcomes.

In embodiments, outputting the output data can include generating one or more instructions configured to be executed by a mitigation engine to cause the mitigation engine to perform an action corresponding to the mitigation inference. This approach has the technical effect of enabling automated or semi-automated resolution of detected issues, potentially reducing response times and minimizing human error in the failure management process.

According to an aspect of the disclosure, there is provided a computer program product. The computer program product includes one or more computer-readable storage media and program instructions stored on the one or more computer-readable storage media to perform operations. The operations include determining baseline data indicative of one or more sets of baseline metrics corresponding to a multi-tier application architecture based on workload data associated with the multi-tier application architecture. The operations also include determining impact data associated with at least one dependency metric corresponding to the multi-tier application architecture based on runtime data associated with the multi-tier application architecture. Additionally, the operations include outputting output data indicative of a mitigation inference associated with the multi-tier application architecture based on a machine learning component configured to process the baseline data and the impact data. This computer program product improves the efficiency and accuracy of failure management in complex multi-tier application architectures by providing a software solution that combines workload characterization, dependency modeling, and machine learning techniques. Additionally, the computer program product enables more targeted and precise mitigation strategies, potentially reducing downtime and resource waste compared to traditional full-system rollback approaches.

In embodiments, determining the baseline data can include determining a first portion of the baseline data prior to deployment of an application corresponding to the multi-tier application architecture, determining a second portion of the baseline data subsequent to deployment of the application, and determining a third portion of the baseline data during a failure corresponding to the application. This multi-stage approach has the technical effect of providing a comprehensive view of system behavior across different operational states, enabling more accurate detection of deviations from normal behavior and facilitating targeted mitigation strategies.

In embodiments, determining the impact data can include determining a first portion of the impact data prior to deployment of an application corresponding to the multi-tier application architecture, determining a second portion of the impact data subsequent to deployment of the application, and determining a third portion of the impact data during a failure corresponding to the application. This approach has the technical effect of providing a comprehensive understanding of system dependencies and impacts across different stages of the application lifecycle, enabling more effective failure management and mitigation strategies.

In embodiments, the operations can include determining the mitigation inference based on the baseline data and the impact data. Determining the mitigation inference can include recommending a restoration action, recommending a partial restoration action, recommending a rollback action, or recommending a partial rollback action. This feature has the technical effect of providing tailored mitigation strategies based on the specific nature and scope of detected issues, potentially reducing unnecessary disruptions to unaffected parts of the system.

In embodiments, the operations can include training the machine learning component based on historical data associated with at least one of the multi-tier application architecture or another multi-tier application architecture having a configuration similarity with a configuration of the multi-tier application architecture. This approach has the technical effect of improving the accuracy and effectiveness of the mitigation inferences over time as the system learns from past experiences and outcomes.

In embodiments, outputting the output data can include generating one or more instructions configured to be executed by a mitigation engine to cause the mitigation engine to perform an action corresponding to the mitigation inference. This feature has the technical effect of enabling automated or semi-automated resolution of detected issues, potentially reducing response times and minimizing human error in the failure management process.

According to an aspect of the disclosure, there is provided a computer system. The computer system includes a processor set, one or more computer-readable storage media, and program instructions stored on the one or more computer-readable storage media to cause the processor set to perform operations. The operations include determining baseline data indicative of one or more sets of baseline metrics corresponding to a multi-tier application architecture based on workload data associated with the multi-tier application architecture. The operations also include determining impact data associated with at least one dependency metric corresponding to the multi-tier application architecture based on runtime data associated with the multi-tier application architecture. Additionally, the operations include outputting output data indicative of a mitigation inference associated with the multi-tier application architecture based on a machine learning component configured to process the baseline data and the impact data. This computer system improves the efficiency and accuracy of failure management in complex multi-tier application architectures by providing a hardware and software solution that combines workload characterization, dependency modeling, and machine learning techniques. Additionally, the computer system enables more targeted and precise mitigation strategies, potentially reducing downtime and resource waste compared to traditional full-system rollback approaches.

In embodiments, the operations can include training the machine learning component based on the baseline data, the impact data, and the output data. This approach has the technical effect of continuously improving the accuracy and effectiveness of the mitigation inferences by incorporating feedback from actual system events and the outcomes of mitigation actions.

In embodiments, outputting the output data can include generating one or more instructions configured to be executed by a mitigation engine to cause the mitigation engine to perform an action corresponding to the mitigation inference. This feature has the technical effect of enabling automated or semi-automated resolution of detected issues, potentially reducing response times and minimizing human error in the failure management process.

This combination enables more accurate and targeted failure detection and mitigation in multi-tier application architectures by incorporating specific HTTP request/response metrics. The inclusion of time-series HTTP metrics allows for the identification of temporal patterns in system behavior, potentially improving the ability to predict and prevent failures before they occur.

This combination provides a more comprehensive approach to failure management by considering both HTTP request/response failures and patterns of repeated requests. The inclusion of repeat request metrics can help identify potential issues related to user behavior or system performance that may not be apparent from HTTP failure codes alone, leading to more effective mitigation strategies.

This combination provides a holistic approach to failure management by incorporating HTTP failures, repeat requests, and general performance metrics. The inclusion of time-series performance metrics allows for a more nuanced understanding of system behavior over time, potentially enabling the detection of gradual performance degradation before it leads to critical failures.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
determining, based on workload data associated with a multi-tier application architecture, baseline data indicative of one or more sets of baseline metrics corresponding to the multi-tier application architecture;
determining, based on runtime data associated with the multi-tier application architecture, impact data associated with at least one dependency metric corresponding to the multi-tier application architecture; and
outputting, based on a machine learning component configured to process the baseline data and the impact data, output data indicative of a mitigation inference associated with the multi-tier application architecture.

2. The computer-implemented method of claim 1, wherein determining the baseline data comprises:
obtaining failure codes associated with hypertext transfer protocol (HTTP) request response failures corresponding to at least one tier of the multi-tier application architecture; and
determining a set of baseline metrics, of the one or more sets of baseline metrics, based on the failure codes, wherein the set of baseline metrics comprises at least one time-series HTTP request response metric.

3. The computer-implemented method of claim 1, wherein determining the baseline data comprises:
obtaining repeat request data associated with the multi-tier application architecture; and
determining a set of baseline metrics, of the one or more sets of baseline metrics, based on the repeat request data, wherein the set of baseline metrics comprises at least one time-series repeat request metric.

4. The computer-implemented method of claim 1, wherein determining the baseline data comprises:
obtaining performance metric data associated with the multi-tier application architecture; and
determining a set of baseline metrics, of the one or more sets of baseline metrics, based on the performance metric data, wherein the set of baseline metrics comprises at least one time-series performance metric.

5. The computer-implemented method of claim 1, wherein determining the baseline data comprises:
obtaining ticket trend data associated with the multi-tier application architecture; and
determining a set of baseline metrics, of the one or more sets of baseline metrics, based on the ticket trend data, wherein the set of baseline metrics comprises at least one time-series ticket trend metric.

6. The computer-implemented method of claim 1, wherein the one or more sets of baseline metrics comprise, for each time slice of a plurality of consecutive time slices, a plurality of sets of baseline metrics, each set of baseline metrics of the plurality of sets of baseline metrics corresponding to a respective tier of the multi-tier application architecture.

7. The computer-implemented method of claim 1, wherein determining the impact data comprises:
obtaining the runtime data by dynamically monitoring the multi-tier application architecture during runtime;
creating a component interaction model associated with the multi-tier application architecture based on the runtime data; and
performing dependency modeling on the component interaction model to detect at least one set of dependency metrics associated with the multi-tier application architecture.

8. The computer-implemented method of claim 1, wherein determining the impact data comprises:
obtaining the runtime data by dynamically monitoring the multi-tier application architecture during runtime; and
creating an impact matrix associated with the multi-tier application architecture based on the runtime data, the impact matrix indicating, for each activity of one or more monitored activities, a set of impacted tiers of the multi-tier application architecture.

9. The computer-implemented method of claim 1, further comprising determining, based on the baseline data and the impact data, the mitigation inference, wherein determining the mitigation inference comprises at least one of:
recommending a restoration action;
recommending a partial restoration action;
recommending a rollback action; or
recommending a partial rollback action.

10. The computer-implemented method of claim 1, further comprising training the machine learning component based on historical data associated with at least one of the multi-tier application architecture or another multi-tier application architecture having a configuration similarity with a configuration of the multi-tier application architecture.

11. The computer-implemented method of claim 1, wherein outputting the output data comprises:
generating, based on the mitigation inference, one or more instructions configured to be executed by a mitigation engine to cause the mitigation engine to perform an action corresponding to the mitigation inference.

12. A computer program product, comprising:
one or more computer-readable storage media; and
program instructions stored on the one or more computer-readable storage media to perform operations, comprising:
determining, based on workload data associated with a multi-tier application architecture, baseline data indicative of one or more sets of baseline metrics corresponding to the multi-tier application architecture;
determining, based on runtime data associated with the multi-tier application architecture, impact data associated with at least one dependency metric corresponding to the multi-tier application architecture; and
outputting, based on a machine learning component configured to process the baseline data and the impact data, output data indicative of a mitigation inference associated with the multi-tier application architecture.

13. The computer program product of claim 12, wherein determining the baseline data comprises:
determining a first portion of the baseline data prior to deployment of an application corresponding to the multi-tier application architecture;
determining a second portion of the baseline data subsequent to deployment of the application; and
determining a third portion of the baseline data during a failure corresponding to the application.

14. The computer program product of claim 12, wherein determining the impact data comprises:
determining a first portion of the impact data prior to deployment of an application corresponding to the multi-tier application architecture;
determining a second portion of the impact data subsequent to deployment of the application; and
determining a third portion of the impact data during a failure corresponding to the application.

15. The computer program product of claim 12, the operations further comprising determining, based on the baseline data and the impact data, the mitigation inference, wherein determining the mitigation inference comprises at least one of:
recommending a restoration action;
recommending a partial restoration action;
recommending a rollback action; or
recommending a partial rollback action.

16. The computer program product of claim 12, the operations further comprising training the machine learning component based on historical data associated with at least one of the multi-tier application architecture or another multi-tier application architecture having a configuration similarity with a configuration of the multi-tier application architecture.

17. The computer-implemented method of claim 1, wherein outputting the output data comprises:
generating, based on the mitigation inference, one or more instructions configured to be executed by a mitigation engine to cause the mitigation engine to perform an action corresponding to the mitigation inference.

18. A computer system, comprising:
a processor set;
one or more computer-readable storage media; and
program instructions stored on the one or more computer-readable storage media to cause the processor set to perform operations comprising:
determining, based on workload data associated with a multi-tier application architecture, baseline data indicative of one or more sets of baseline metrics corresponding to the multi-tier application architecture;
determining, based on runtime data associated with the multi-tier application architecture, impact data associated with at least one dependency metric corresponding to the multi-tier application architecture; and
outputting, based on a machine learning component configured to process the baseline data and the impact data, output data indicative of a mitigation inference associated with the multi-tier application architecture.

19. The computer system of claim 18, further comprising training the machine learning component based on the baseline data, the impact data, and the output data.

20. The computer system of claim 18, wherein outputting the output data comprises:
generating, based on the mitigation inference, one or more instructions configured to be executed by a mitigation engine to cause the mitigation engine to perform an action corresponding to the mitigation inference.
